(19) United States
(12) Patent Application Publication
(10) Pub. No.: US 2022/0113791 A1
(43) Pub. Date: Apr. 14, 2022

(54) TERMINAL APPARATUS AND METHOD FOR CONTROLLING TERMINAL APPARATUS

(71) Applicant: NTT DOCOMO, INC., Chiyoda-ku (JP)

(72) Inventors: Shigeru AKAMATSU, Chiyoda-ku (JP); Koichi ASANO, Chiyoda-ku (JP)

(73) Assignee: NTT DOCOMO, INC., Chiyoda-ku (JP)

(21) Appl. No.: 17/265,869

(22) PCT Filed: Jun. 10, 2019
(86) PCT No.: PCT/JP2019/022884

§ 371 Date: Feb. 4, 2021

(30) Foreign Application Priority Data
Aug. 8, 2018 (JP) 2018-149268

(51) Int. Cl. G06F 3/01; G06F 3/04815; G02B 27/01; G06T 19/00

(52) U.S. Cl. CPC G06F 3/011; G06F 3/04815; G02B 27/0101; G02B 2027/0178; G06T 19/006; G02B 2027/0138; G02B 27/017

(57) ABSTRACT

A terminal apparatus has a first determiner that determines whether a specific object with a two-dimensional manipulation plane has appeared inside a viewing frame of a virtual space provided to a user; a second determiner that, in a case in which it is determined that the specific object has appeared inside the viewing frame, determines whether the specific object overlaps a specific point inside the viewing frame; and a display controller that: in a case in which it is determined that the specific object overlaps the specific point, control the display device to display in the viewing frame a two-dimensional pointer movable relative to the two-dimensional manipulation plane, and in a case in which it is determined that the specific object does not appear inside the viewing frame, control the display device to display in the viewing frame a three-dimensional pointer that moves within the virtual space three dimensionally.

### TECHNICAL FIELD

The present invention relates to a terminal apparatus and to a method for controlling the terminal apparatus.

### BACKGROUND ART

In recent years, technologies are known to provide to a user wearing a head-mounted display a virtual or real space, by synthesizing various objects. While such a space is provided in three dimensions by a computer or the like, an interface for a user to carry out instructions and/or inputs is often provided in two dimensions by way of a graphical user interface (GUI). In such cases, technologies are proposed to switch between a mode of inputting to or operating an object displayed in three dimensions, and a mode of inputting to or operating an object displayed in two dimensions, by using a manipulation device that detects translational and rotational movements (see, for example, Patent Document 1).

### RELATED ART

### Patent Document

Patent Document 1 Japanese Patent Application Laid-Open Publication 2014-25666

### SUMMARY OF THE INVENTION

### Problem to be Solved by the Invention

For simplicity, the head-mounted display may be constituted of a smartphone and goggles, for example. In such a case, however, the above technology requires a separate manipulation device, and it also inhibits simplification.

### Means of Solving the Problem

In order to solve one of the abovementioned problems, a terminal apparatus according to one aspect of the present invention includes a first determiner configured to determine whether a specific object with a two-dimensional manipulation plane has appeared inside a viewing frame of a virtual space provided to a user; a second determiner configured to, in a case in which it is determined that the specific object has appeared inside the viewing frame, determine whether the specific object overlaps a specific point inside the viewing frame; and a display controller configured to, in a case in which it is determined that the specific object overlaps the specific point, control a display device to display in the viewing frame a two-dimensional pointer movable relative to the two-dimensional manipulation plane, and in a case in which it is determined that the specific object does not appear inside the viewing frame, control the display device to display in the viewing frame a three-dimensional pointer that moves within the virtual space three dimensionally.

According to the terminal apparatus of the above aspect, a three-dimensional pointer is displayed if a specific object does not appear within a viewing frame of the real space provided to the user, and a two-dimensional pointer is displayed if the specific object overlaps a specific point inside the viewing frame. Therefore, a smartphone or the like can be applied as a terminal apparatus having a processor that executes the program, so that the user can switch between the two-dimensional operation and the three-dimensional operation in a simple configuration without any difficulty.

### BRIEF DESCRIPTION OF THE DRAWINGS

FIG. 1 is a view showing a head-mounted display to which a terminal apparatus according to an embodiment is applied.

FIG. 2 is a block diagram showing a configuration of the terminal apparatus.

FIG. 3 is a block diagram showing an example configuration of functions built in the terminal apparatus.

FIG. 4 is an example of a virtual space provided by a display device of the terminal apparatus.

FIG. 5 is a flowchart showing an example of an operation of the terminal apparatus.

FIG. 6 is an example of a three-dimensional pointer displayed in a virtual space.

FIG. 7 is an example of manipulation by a user.

FIG. 8 is an example of the three-dimensional pointer displayed in the virtual space.

FIG. 9 is an example of a two-dimensional pointer displayed in the virtual space.

### MODES FOR CARRYING OUT THE INVENTION

A mode for carrying out the present invention will be described below with reference to the drawings. An embodiment described below is a preferred specific example of the present invention, and various technically preferred limitations are added thereto. However, the scope of the invention is not limited to these forms, unless it is specifically stated in the following description that the invention is limited.

### Embodiment

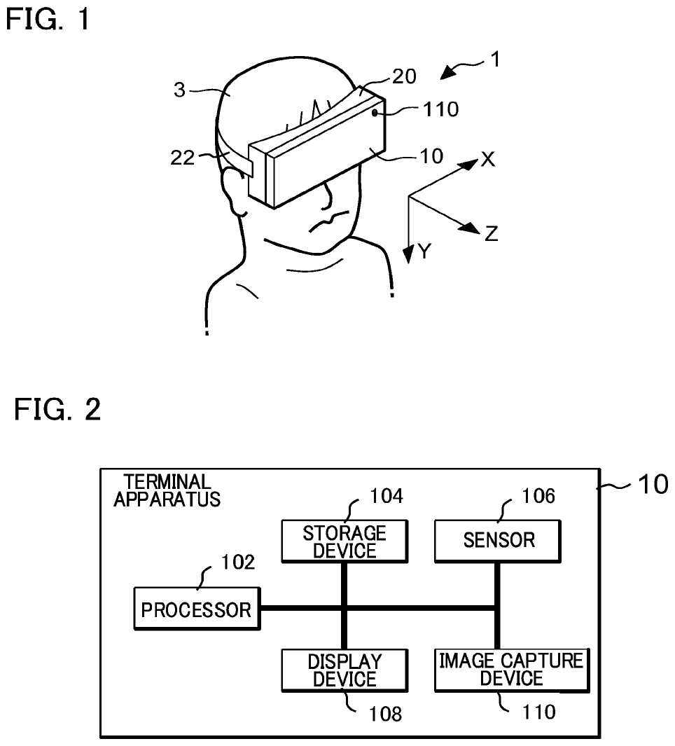

FIG. 1 is a diagram for explaining an overview of a head-mounted display (hereafter referred to as HMD) 1. As shown in this figure, the HMD 1 includes a terminal apparatus 10 according to an embodiment and goggles 20 to which the terminal apparatus 10 is mounted. The goggles 20 are attached to the head of a user 3 by a headband 22 at a position where the terminal apparatus 10 is in front of both eyes of the user 3.

The terminal apparatus 10 is, for example, a smartphone, and a surface facing the user 3 is the front surface thereof. A display device is disposed on the front surface, although it is hidden in the figure. A mounting surface of the goggles 20 for mounting the terminal apparatus 10 has, although not particularly illustrated, an opening for making only an image for the left eye visible to the left eye of the user 3 and an opening for making only an image for the right eye visible to the right eye of the user 3. This allows the user 3 to see a virtual space indicated by a displayed image in a three-dimensional manner in a case in which, in order to provide a virtual space, the display device of the terminal apparatus 10 displays an image for the left eye in an area corresponding to the opening of the left eye and an image for the right eye in an area corresponding to the opening of the right eye by imparting parallax thereto.

An image capture device 110 is positioned on the backside of the terminal apparatus 10, i.e., a side at front in FIG. 1. The terminal apparatus 10 is not limited to a smartphone, and it may also be a display device dedicated to HMDs mounted to goggles. The terminal apparatus 10 may be an HMD device with goggles (i.e., undetachable from the goggles).

FIG. 2 is a diagram showing a hardware configuration of the terminal apparatus 10. As shown in the figure, the terminal apparatus 10 is realized by a computer system that has a processor 102, a storage device 104, a sensor 106, a display device 108, and the image capture device 110. Each element of the terminal apparatus 10 is connected to each other by a single bus or multiple buses. The term “apparatus” in this description may be replaced with another term such as circuit, device, or unit. Each element of the terminal apparatus 10 comprises a single device or plurality of devices. Some elements of the terminal apparatus 10 may be omitted.

The processor 102 controls the entire terminal apparatus 10 and comprises, for example, a single chip or multiple chips. The processor 102 is constituted of, for example, a central processor (CPU) including an interface with peripheral devices, an arithmetic unit and registers, and the like. Some or all of the functions of the processor 102 can be performed by a Digital Signal Processor (DSP), Application Specific Integrated Circuit (ASIC), Programmable Logic Device (PLD), FPGA (FPGA) (Field Programmable Gate Array) or other hardware. The processor 102 executes various processes in parallel or sequentially.

The storage device 104 is a recording medium that can be used by the processor 102 and stores a plurality of programs executed by the processor 102 and various data used by the processor 102. The plurality of programs executed by the processor 102 includes an operating system (OS), and an application program that provides a virtual space to the user 3. The various data include information indicative of a position of an object to be manipulated placed by the user in the virtual space, as described below. The storage device 104 may, for example, include one or more types of ROM (Read Only Memory), EPROM (Erasable Programmable ROM), EEPROM (Electrically Erasable Programmable ROM), RAM (Random Access Memory) and other types of memory circuits.

The sensor 106 is a three-axis angle sensor, for example, for detecting the orientation and movement of the terminal apparatus 10. The display device 108 displays various images (including still images and moving images) under control by the processor 102. In particular, in this embodiment, the image for the left eye and the image for the right eye showing the aforementioned virtual space are displayed by the display device 108. Various display panels, such as liquid crystal display panels or organic EL display panels, may be suitably used as the display device 108. The image capture device 110 is a rear camera disposed on the backside of the terminal apparatus 10. When the user 3 wears the goggles 20 to which the terminal apparatus 10 is mounted, the image capture device 110 captures an image of the direction in which the face of the user 3 is facing.

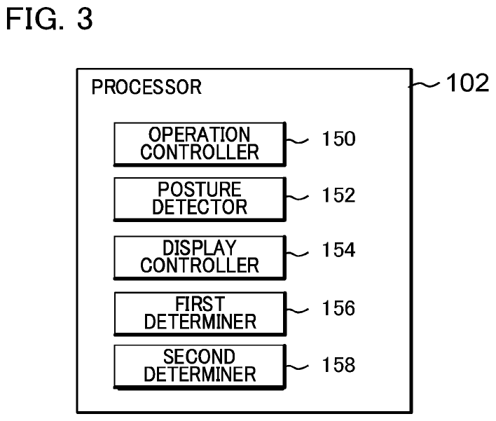

FIG. 3 is a block diagram showing a functional configuration realized by the processor 102 of the terminal apparatus 10 executing the program providing the virtual space. As shown in this figure, an operation controller 150, a posture detector 152, a display controller 154, a first determiner 156, and a second determiner 158 are realized in the terminal apparatus 10.

The posture detector 152 processes a signal output from the sensor 106 and outputs processed results as the posture information of the terminal apparatus 10. Specifically, the posture detector 152 processes the detection results of the sensor 106, i.e., the detection results of each acceleration in the X-axis in the horizontal direction, the Y-axis in the vertical direction, and the Z-axis in the depth direction, as shown in FIG. 1, and outputs the posture information of the terminal apparatus 10 periodically, for example, every 0.02 seconds.

The display controller 154 generates and controls the screen displayed by the display device 108. Specifically, the display controller 154 generates respective images for the left eye and for the right eye for enabling stereoscopic view in the virtual space, and displays the image for the left eye in an area corresponding to the opening of the left eye and the image for the right eye in an area corresponding to the opening of the right eye, respectively, in the display area of the display device 108. The virtual space is a space that simulates the reality generated in the terminal apparatus 10. The virtual space is a concept that extends in all directions around the user 3. In the omnidirectional space, a space corresponding to a direction in which the face of the user 3 is facing, which is detected based on the posture information of the terminal apparatus 10, is partially cut out and displayed on the display device 108.

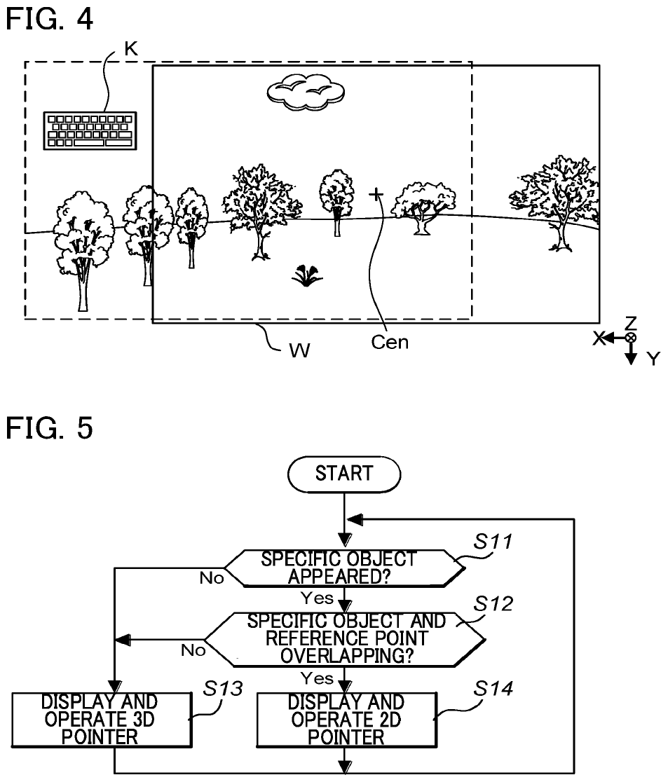

FIG. 4 is a diagram for describing the virtual space provided by the terminal apparatus 10. In this figure, reference sign W is a viewing frame that serves as a cutout frame of the virtual space when the face of the user 3, when wearing goggles 20 to which the terminal apparatus 10 is mounted, is facing in a certain direction. This figure is an example of a natural landscape provided as a virtual space. Since the virtual space is provided to the user 3 in stereoscopic view with images for the left eye and images for the right eye, the viewing frame W does not comprise the screen itself displayed on the display device 108.

A case is assumed in which the face of the user 3 is turned in a certain direction and a virtual space of a natural landscape, as shown in the figure by the solid line viewing frame W in FIG. 4, is provided. If the user 3 rotates the head and turns to face to the left (in the X-axis direction), posture information corresponding to the rotation is output from the posture detector 152. After acquiring the posture information, the display controller 154 moves the viewing frame W, to the position as indicated by the dashed line in FIG. 4, to move the virtual space provided to the user 3 to the left. Since the virtual space moves in this manner according to the direction in which the face is facing, the user 3 can obtain a sensation, through vision, as if the user were in a space in which a natural landscape exists.

Reference sign Cen indicates a reference point fixed in the viewing frame W A reference point Cen is an example of a specific point. In this example, the reference point Cen is located at the diagonal center of the viewing frame W. The reference point Cen is fixed to the viewing frame W. Therefore, the reference point Cen is fixed with respect to the viewing frame W even if the direction of the face changes, and consequently the virtual space cut off by the viewing frame W changes. On the other hand, the reference point Cen moves relative to the virtual space. The reference point Cen is not limited to the diagonal center of the viewing frame W, and it may be a point having a predetermined relationship to the viewing frame W. For example, the reference point Cen may be an intersection of a vertical line dividing the viewing frame W into a ratio of 2:3 transversally, and a parallel line dividing the viewing frame W into a ratio of 3:2 longitudinally. The reference point Cen is shown in FIG. 4 as the intersection of the cross-hairs for convenience of explanation, but the intersection and the cross-hairs are not displayed in actuality in the present embodiment.

In this embodiment, various objects to be manipulated are arranged in the virtual space. Here, an object to be manipulated is for the user 3 to carry out various inputs, settings, and the like in the virtual space, and may be a software button, a software keyboard, a radio button, or a check box. In this embodiment, among the various objects to be manipulated, an object having a manipulation plane as viewed from the user 3 and being a predetermined object, specifically, one that requires accuracy in designating a position of the manipulation plane, is called a specific object. In other words, an object to be manipulated that has the above manipulation plane but is not predetermined is not a specific object. The manipulation plane is preferably parallel to the X-Y plane, but it may not be parallel. The manipulation plane may not be flat, and it may have an uneven surface, such as an e-book. Some of these objects to be manipulated are placed at freely selected positions in the virtual space by the user, while others are placed inside the viewing frame W by execution of the application program. Information on the position of an object to be manipulated placed in the virtual space by the user is stored in the storage device 104 by the operation controller 150, for example.

In this embodiment, a software keyboard that requires accuracy in designating a position on the manipulation plane when designating one of many keys from among the objects to be manipulated is defined as a specific object. On the other hand, a software button that does not require as much precision as a software keyboard to specify a position when specifying one of the button areas (i.e., the precision required to specify a position is lower than that required of a software keyboard) is not considered a specific object. However, a software button may be a specific object in some cases, as described below. A radio button or a checkbox used for application program settings and the like may or may not be a specific object.

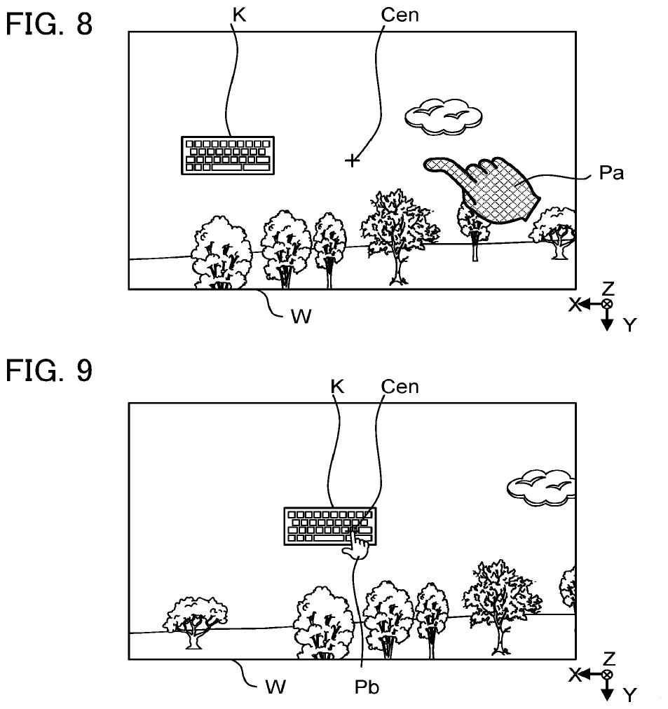

FIG. 4 shows an example in which a specific object, a software keyboard K, is placed outside the viewing frame W in the virtual space. If the user 3 turns the head to the left, as shown in FIG. 8, which will be described later, the viewing frame W will move to the left with the rotation, and the software keyboard K will be displayed inside the viewing frame W as a result of the movement.

Explanation now returns to FIG. 3. The first determiner 156 determines whether a specific object has appeared inside the viewing frame W, and the second determiner 158 determines whether the specific object appearing inside the viewing frame W overlaps the reference point Cen as viewed from the user 3, if the determination by the first determiner 156 is affirmative. That the specific object has appeared inside the viewing frame W means that one, some, or all of the specific objects are displayed in the virtual space when the display controller 154 displays a virtual space on the display device 108 after cutting out the virtual space with the viewing frame W depending on the posture of the terminal apparatus 10.

In this embodiment, the pointer for manipulation is switched depending on whether or not a specific object appears inside the viewing frame W and, if so, depending on whether or not the specific object overlaps the reference point Cen. The next section describes a pointer switching operation.

FIG. 5 is a flowchart showing an operation of switching the pointer. This operation is executed when a virtual space is provided to the user by execution of an application program on the terminal apparatus 10. That is, the pointer switching operation is performed in a case in which a virtual space is provided to the user 3 after the virtual space is cut out by the viewing frame W depending on the direction in which the face of the user 3 is facing (strictly speaking, the direction based on the posture of the terminal apparatus 10).

In such a case, if there is a specific object placed by the user in the virtual space from among the objects to be manipulated, the display controller 154 obtains the position of the specific object from the storage device 104. If there is a specific object placed in the viewing frame W by execution of the application program, the display controller 154 obtains the position of the specific object from the application program. Then, the display controller 154 displays the object to be manipulated in the virtual space if the face of the user 3 turns toward the object to be manipulated, which has been placed in the acquired position.

First, the first determiner 156 determines whether one, some, or all of the specific objects currently appear inside the viewing frame W (step S11).

If no specific object appears inside the viewing frame W (the determination result of step S11 is “No”), the processing procedure proceeds to step S13. On the other hand, if a specific object has appeared inside the viewing frame W (indicating that the determination result of step S11 is “Yes”), the second determiner 158 determines whether the specific object appearing overlaps the reference point Cen as viewed from the user 3 (step S12).

If there is no overlap between the specific object and the reference point Cen (the determination result of step S12 is “No”), the process proceeds to step S13. On the other hand, if the specific object and the reference point Cen overlap (the determination result of step S12 is “Yes”), the process proceeds to step S14.

In step S13, the display controller 154 controls the display device 108 to display a three-dimensional pointer inside the viewing frame W. The display controller 154 controls the display device 108 to display the three-dimensional pointer inside the viewing frame W, and further controls the display device 108 so that the three-dimensional pointer moves inside the viewing frame W in response to a movement of the user's hand (manipulating body), an image of which is captured by the image capture device 110 for example.

In a case in which the three-dimensional pointer overlaps an object to be manipulated other than a specific object, as viewed from the user 3, the case being accompanied by a specific action carried out by the user 3, the operation controller 150 executes a command associated with the action.

In step S14, the display controller 154 controls the display device 108 to display a two-dimensional pointer inside the viewing frame W. The display controller 154 controls the display device 108 to display the two-dimensional pointer inside the viewing frame W, and further controls the display device 108 so that, when the posture detector 152 detects a change in the posture of the terminal apparatus 10, the two-dimensional pointer moves, inside the viewing frame W, on the manipulation plane of the specific object depending on the change. In a case in which the two-dimensional pointer overlaps the manipulation area of the specific object as viewed from the user 3, the case being accompanied by a specific action by the user 3, the operation controller 150 executes a command associated with the action.

After the display controller 154 displays the three-dimensional pointer or two-dimensional pointer on the display device 108, the process returns to step S11. After this, in this embodiment, if there is no change in the presence or absence of the specific object in the viewing frame W and in the positional relationship between the specific object and the reference point Cen, the same pointer continues to be displayed. On the other hand, if there is a change, the pointer may be switched between the two-dimensional pointer and the three-dimensional pointer. It is to be noted that the operation controller 150 may control the posture detector 152, the display controller 154, the first determiner 156, and the second determiner 158.

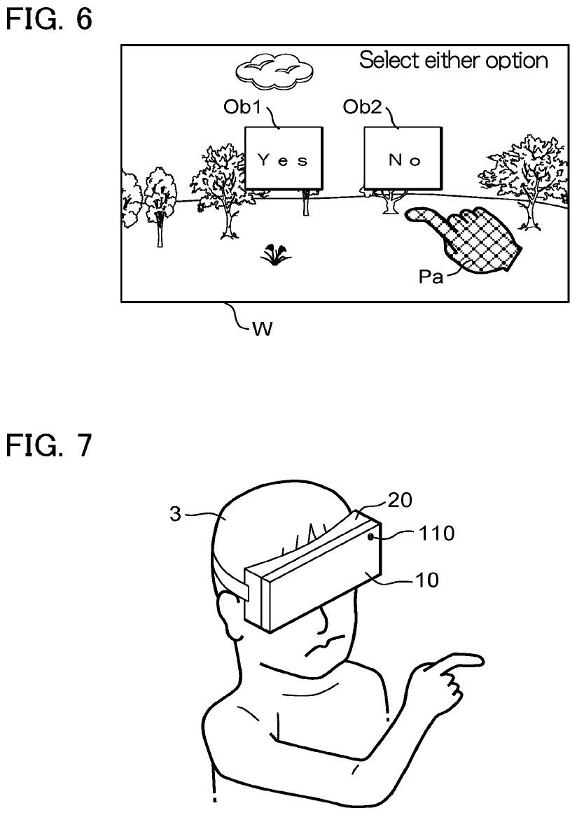

Next, an example of a virtual space provided to a user is described. FIG. 6 shows an example display of a virtual space cut out with the viewing frame W in the absence of a specific object. In this example, there are displayed, as objects to be manipulated, a software button Ob1 for making the user 3 select an affirmative answer and a software button Ob2 for making the user 3 select a negative answer. As mentioned above, in the present embodiment, the software button is not a specific object, so in the example of FIG. 6, the determination result of step S11 is “No”. Therefore, a three-dimensional pointer Pa is displayed inside the viewing frame W.

When an image of a real space including a manipulating body of a predetermined shape is captured by the image capture device 110, the image of the manipulating body is cut out from the background image of the real space by image processing, and the image of the cut out manipulating body is synthesized with an image of the virtual space for display. This is how an image of the three-dimensional pointer Pa is displayed. The manipulating body of the predetermined shape is, for example, a hand of the user 3 ranging from the fingertip to the wrist. The manipulating body of the predetermined shape is not limited to the hand, but and it may be something that can be photographed by the image capture device 110 and can be moved as desired by the user 3. The manipulating body may be, for example, a pen tip or the like operated by the user 3.

Specifically, as shown in FIG. 7, if the user 3 wearing the goggles 20 to which the terminal apparatus 10 is mounted makes a gesture such as if to point at something with the index finger of the right hand in the imaging area of the image capture device 110, the image of the three-dimensional pointer Pa, the form of which is the right hand cut out from the background image of the imaging area, is synthesized with the image of the virtual space and displayed as shown in FIG. 6.

The three-dimensional pointer Pa, when displayed in the virtual space, may be, by image processing, an image cut out of the background, an image filled in inside the outline of the cut out image, or a computer graphic (CG) unrelated to the background image.

When the user 3 operates the right hand and touches the software button Ob1 or Ob2, specifically, when the user 3 makes a portion of the three-dimensional pointer Op overlap a square frame in which the software button Ob1 is displayed or a square frame in which the software button Ob2 is displayed, the operation controller 150 determines that one of the software buttons that the three-dimensional pointer Op overlaps has been touched. For example, if it is determined that the software button Ob1 has been touched, then the operation controller 150 notifies, to an application program or an OS that had the software buttons Ob1 and Ob2 displayed, that the user has given an affirmative answer to a given question. As a result, a command associated with the software button Ob1 will be executed.

If the user 3, for example, moves the right hand in a depth direction (away from the user), the captured image of the right hand becomes smaller. In contrast, if the user 3 moves the right hand in the direction of approaching the user, the captured image of the right hand becomes larger. Thus, the size of the displayed three-dimensional pointer P depends on the Z-axis coordinates. For this reason, the size of the displayed three-dimensional pointer P may be used to determine the Z-axis coordinates of the three-dimensional pointer.

FIG. 8 shows an example of a display when the software keyboard K, which is a specific object, appears inside the viewing frame W, but the software keyboard K does not overlap the reference point Cen. FIG. 8 is an example of a case in which, for example, the software keyboard K is displayed inside the viewing frame W as a result of the user 3 rotating the head to the left and upward in the state shown in FIG. 4, in which the software keyboard K is positioned to the left of (outside) the viewing frame W.

In the example in FIG. 8, the determination result of step S11 is “Yes”. However, since the determination result of step S12 is “No”, the three-dimensional pointer Pa is displayed inside the viewing frame W. If an image of the manipulating body of the predetermined shape is not captured in the shooting area by the image capture device 110, the three-dimensional pointer P is not displayed.

FIG. 9 illustrates an example display in which the software keyboard K, which is a specific object, appears inside the viewing frame W and the software keyboard K overlaps the reference point Cen. FIG. 9 is an example of a case in which the user 3 turns the head further to the left, for example, in a state in which the software keyboard K is disposed inside the viewing frame W, as shown in FIG. 8.

In the example in FIG. 9, a two-dimensional pointer Pb is displayed inside the viewing frame W because the result of the determination in step S11 is “Yes” and the result of the determination in step S12 is also “Yes”. The two-dimensional pointer Pb has a pattern that mimics a right hand. However, for the purpose of distinguishing the two-dimensional pointer Pb from the three-dimensional pointer Pa at first glance, the two-dimensional pointer Pb and the three-dimensional pointer Pa may be mutually different in shape or color, or both.

The tip of the index finger of the two-dimensional pointer Pb in FIG. 9 is a point specified by the pointer, and in the present embodiment, the specified point is fixed at the reference point Cen. Therefore, when the user 3 moves the point specified by the index finger tip of the two-dimensional pointer Pb, the user 3 will have to turn the head upward, downward, leftward or rightward. Specifically, when a certain key is entered on the software keyboard K, the user 3 points the head in a direction in which the tip of the index finger of the two-dimensional pointer Pb overlaps a manipulation area corresponding to the key and fixes the head to maintain the overlapped state for a certain period of time (e.g., 2 seconds).

When another key is entered, the user 3 similarly points the head in a direction in which the tip of the index finger of the two-dimensional pointer Pb overlaps the manipulation area of the other key, and fixes the head to maintain the overlapped state for a certain period of time. When the same key is entered twice in succession, the user 3, for example, inputs the first key and then moves the head once to a position where the two-dimensional pointer Pb overlaps the manipulation area of another key. Then, after moving the head to a position where the two-dimensional pointer Pb overlaps the manipulation area of the same key again, the user 3 may fix the head and maintain the overlapped state for a certain period of time.

If the software keyboard K no longer overlaps the reference point Cen as a result of the user 3 moving the direction in which the head is facing, the result of the determination in step S12 is “No” and the two-dimensional pointer Pb is changed to the three-dimensional pointer Pa as shown in FIG. 8. Unlike the three-dimensional pointer Pa, the two-dimensional pointer Pb does not move in the depth direction, but rather, it moves relative to the manipulation plane of the software keyboard K.

According to the present embodiment, the two-dimensional pointer Pb utilizes the detection results of the sensor 106 of the terminal apparatus 10, and thus, it is possible to specify a position with higher accuracy than with the three-dimensional pointer Pa, which is manipulated by way of movement of a fingertip or the like by a user.

On the other hand, in the present embodiment, when a specific object such as the software keyboard K does not overlap the reference point Cen, i.e., when no input, setting, etc., is performed using the specific object, there is displayed the three-dimensional pointer Pa movable in the three-axis directions, including the Z axis in addition to the X and Y axes. Therefore, it is possible to specify a position considering depth.

Furthermore, in the present embodiment, one of the three-dimensional pointer Pa and the two-dimensional pointer Pb is switched to the other according to the direction in which the head is facing. Thus, the switching can be achieved with a simple configuration without causing any inconvenience to the user and without separately preparing a special operating device.

### Various Applications and Modifications

In a configuration according to the embodiment, after fixing the two-dimensional pointer Pb to the reference point Cen, the specific object is moved in accordance with a direction in which the head is facing, and then a manipulation area of the specific object is specified with the two-dimensional pointer Pb. However, in a state in which the specific object overlaps the reference point Cen, the two-dimensional pointer may be moved on the manipulation plane of the specific object in accordance with a manipulation by the user 3.

In the above-described embodiment, from among the objects to be manipulated, only the software keyboard is a specific object. However, it may be configured to allow the user to set, for each of different types of objects to be manipulated whether to set the object as a specific object.

When the specific object is the software keyboard K as described above, a manipulation area corresponding to each of a plurality of keys is provided in the area where the software keyboard K is displayed. Here, an area other than the keys is a non-manipulation area, so that even if the area other than the keys is specified with the two-dimensional pointer Pb, it does not constitute a significant manipulation. In other words, the software keyboard K is an example of a plurality of manipulation areas disposed in a part of the area of a specific object.

However, the present invention is not limited thereto. For example, when a specific object includes a single software button, the entire area of the software button may be the manipulation area of the specific object. In other words, an example in which one software button is a specific object is an example of a case in which the entire area of the specific object is a manipulation area. Furthermore, for example, in a case in which a plurality of software buttons are placed in a specific object and are separated from each other, each area of the plurality of software buttons is a manipulation area, and an area other than the buttons is a non-manipulation area. In other words, an example in which a plurality of software buttons are included in a specific object is an example of a case in which a plurality of manipulation areas are arranged in a part of the area of the specific object.

In a case in which a manipulation area to which a command is associated is disposed in part or entirety of a specific object, if the manipulation area is specified by the two-dimensional pointer Pb, the operation controller 150 executes a command associated with the manipulation area. In a case in which a plurality of manipulation areas with each of which a respective one of different commands is associated are arranged in a part of a specific object, if any of the plurality of manipulation areas is specified by the two-dimensional pointer Pb, the operation controller 150 executes a command associated with the specified manipulation area. In a case which one manipulation area to which a command is associated is arranged in the entire portion of the specific object, if the manipulation area is specified by the two-dimensional pointer Pb, the operation controller 150 executes a command associated with the specified manipulation area.

Instead of hiding the reference point Cen, the reference point Cen may be displayed in such a way that the user 3 can reliably recognize the position of the reference point Cen.

In the above-described embodiment, a key is entered when the manipulation area of the key of the software keyboard K is specified by the two-dimensional pointer Pb for a certain period of time. However, the present invention is not limited thereto. It may be configured so that a key is entered when the manipulation area of the key is specified by the two-dimensional pointer Pb and a specific action (e.g., drawing a circle) is performed.

In the embodiment, description is given of an example of the HMD 1, which provides a virtual space to the user 3. However, the invention can also be applied, for example, to a case in which an image of an object to be manipulated is synthesized with a real space image captured by the image capture device 110 such that the object to be manipulated is displayed in the real space.

### Appendix

In the illustrated flowchart, the order of steps may be changed. That is, the order of processes in a preferred embodiment of the present invention is not limited to a particular order.

Each of the functions illustrated in FIG. 3 is realized by any combination of hardware and software. Each function may be realized by a single apparatus or by two or more apparatuses configured separately from each other.

A program, whether referred to as software, firmware, middleware, microcode or hardware description language or called by any other name, shall be construed broadly to mean instructions, instruction sets, code, code segments, program code, subprograms, software modules, applications, software applications, software packages, routines, subroutines, objects, executable files, threads of execution, procedures, functions, etc.

The software, instructions, etc., may also be transmitted and received via a transmission medium. For example, when the software is transmitted from a website, server, or other remote sources, by using wired technologies such as coaxial cables, fiber optic cables, twisted-pair cables, and digital subscriber lines (DSL), and/or wireless technologies such as infrared, radio and microwaves, these wired technologies and/or wireless technology are included within the definition of the transmission medium.

The embodiments and modes described herein may be applied to systems that use long term evolution (LTE), LTE-Advanced (LTE-A), SUPER 3G, IMT-Advanced, 4G, 5G, FRA (Future Radio Access), W-CDMA (registered trademark), GSM (registered trademark), CDMA2000, ultra-mobile broadband (UMB), IEEE 802.11 (Wi-Fi), IEEE 802.16 (WiMAX), IEEE 802.20, ultra-wideband (UWB), Bluetooth (registered trademark), and other appropriate systems and/or next generation systems extended based on these systems.

Input/output information, etc., may be stored in a specific location (e.g., memory) or may be managed by a management table. Input/output information, etc., may be overwritten, updated, or additional information may be appended to the input/output information. The output information, etc., may be deleted. The input information, etc., may be transmitted to other devices.

Decisions may be made in values that can be represented by one bit (0 or 1), may be made in Boolean values (true or false), or may be made by comparing numerical values (e.g., comparison against a predetermined value).

Each of the modes and embodiments described herein may be used alone, in combination, or may be switched as they are performed.

The information and signals and the like described herein may be represented by using any of a variety of different technologies. For example, data, instructions, commands, information, signals, bits, symbols, chips, and the like referred to throughout the above description may be represented by voltages, currents, electromagnetic waves, magnetic fields or magnetic particles, optical fields or photons, or any combination thereof.

The information, etc., described herein may be expressed in absolute values, in relative values with respect to a predetermined value, or in other pieces of applicable information.

A mobile station such as a smartphone is suitable as the terminal apparatus 10, as described above. A mobile station may be referred to by those skilled in the art as a subscriber station, a mobile unit, a subscriber unit, a wireless unit, a remote unit, a mobile device, a wireless device, a wireless communicator, a remote device, a mobile subscriber station, an access terminal, a mobile terminal, a wireless terminal, a remote terminal, a handset, a user agent, a mobile client, a client, or some other suitable terms.

The term “connected” or any modification thereof means any direct or indirect connection or coupling between two or more elements, and may include the presence of one or more intermediate elements between two elements that are “connected” to each other. The coupling or connection between the elements may be physical, logical, or a combination of these. As used herein, it may be considered that two elements are “connected” to each other by using one or more wires, cables and/or printed electrical connections and, to name some non-limiting and non-inclusive examples, by using electromagnetic energy, such as electromagnetic energy having wavelengths in the radio frequency domain, microwave domain, and optical (both visible and invisible) domain.

In the above-described embodiment, a recording circuit, such as a ROM and RAM, is given as an example of the storage device 104, but the storage device 104 may be a flexible disk, a magnetic optical disk (e.g., a compact disks, a digital multi-purpose disk, a Blu-ray (registered trademark) disk), a smart card, a flash memory device (e.g., a card, a stick, a key drive), a compact disc-ROM (CD-ROM), a register, a removable disk, a hard disk, a floppy (registered trademark) disk, a magnetic strip, a database, a server, or other suitable storage medium. The program may also be transmitted via a telecommunications line.

In this description, if articles are added by translation, such as “a”, “an” and “the” in English, these articles include the plural, unless the context clearly indicates otherwise.

It should be obvious to those skilled in the art that the present invention is not limited to the embodiments described herein. The invention can be implemented as a modified and changed form without departing from the spirit and scope of the present invention defined based on the recitation of the claims. Accordingly, the description herein is for illustrative purposes only and has no restrictive implications for the invention. A plurality of modes selected from the modes illustrated herein may also be combined.

### DESCRIPTION OF REFERENCE SIGNS

1 . . . HMD, 10 . . . terminal apparatus, 20 . . . goggles, 102 . . . processor, 150 . . . motion controller, 152 . . . posture detector, 154 . . . motion controller, 156 . . . first determiner, 158 . . . second determiner, Pa . . . three-dimensional pointer, Pb . . . two-dimensional pointer, K . . . software keyboard (specific object), Cen . . . reference point, Ob1, Ob2 . . . software button (object to be manipulated).

1. A terminal apparatus comprising:
a first determiner configured to determine whether a specific object with a two-dimensional manipulation plane has appeared inside a viewing frame of a virtual space provided to a user;
a second determiner configured to, in a case in which it is determined that the specific object has appeared inside the viewing frame, determine whether the specific object overlaps a specific point inside the viewing frame; and
a display controller configured to,
in a case in which it is determined that the specific object overlaps the specific point, control a display device to display in the viewing frame a two-dimensional pointer movable relative to the two-dimensional manipulation plane, and
in a case in which it is determined that the specific object does not appear inside the viewing frame, control the display device to display in the viewing frame a three-dimensional pointer that moves within the virtual space three dimensionally.

2. The terminal apparatus according to claim 1,
wherein the display controller is configured to move the two-dimensional pointer on the two-dimensional manipulation plane based on posture information of the terminal apparatus.

3. The terminal apparatus according to claim 1,
further comprising an image capture device configured to capture an image of a manipulating body manipulated by the user,
wherein the display controller is configured to move the three-dimensional pointer three dimensionally within the viewing frame in accordance with movement of the manipulating body captured by the image capture device.

4. The terminal apparatus according to claim 2,
wherein the display controller is configured to display the three-dimensional pointer in a case in which it is determined that the specific object has appeared inside the viewing frame and in which the specific object does not overlap the specific point.

5. The terminal apparatus according to claim 1,
wherein a manipulation area with which a command is associated is arranged in a part or in an entire portion of the specific object,
the terminal apparatus further comprising an operation controller configured to execute the command associated with the manipulation area in a case in which the manipulation area is specified by the two-dimensional pointer.

6. A method for controlling a terminal apparatus, the method comprising:
determining whether a specific object with a two-dimensional manipulation plane has appeared inside a viewing frame of a virtual space provided to a user;
in a case in which it is determined that the specific object has appeared inside the viewing frame, determining whether the specific object overlaps a specific point inside the viewing frame;
in a case in which it is determined that the specific object overlaps the specific point, displaying in the viewing frame a two-dimensional pointer movable relative to the two-dimensional manipulation plane; and
in a case in which it is determined that the specific object does not appear inside the viewing frame, displaying in the viewing frame a three-dimensional pointer that moves within the virtual space three dimensionally.

7. The terminal apparatus according to claim 2,
further comprising an image capture device configured to capture an image of a manipulating body manipulated by the user,
wherein the display controller is configured to move the three-dimensional pointer three dimensionally within the viewing frame in accordance with movement of the manipulating body captured by the image capture device.
